(19) United States
(12) Patent Application Publication
(10) Pub. No.: US 2003/0041057 A1
(43) Pub. Date: Feb. 27, 2003

(54) METHOD AND APPARATUS FOR NOTIFICATION OF USER WHEN CHANGES HAVE OCCURRED IN COMPLEX DERIVATIONS OF DATA

(76) Inventors: DANIEL W. HEPNER, SARATOGA, CA (US); ERIC M. SODERBERG, MOUNTAIN VIEW, CA (US)

Correspondence Address: HEWLETT PACKARD COMPANY, INTELLECTUAL PROPERTY ADMINISTRATION, 3404 E HARMONY ROAD, P.O. BOX 272400, FORT COLLINS, CO, 80528-9599, US

(21) Appl. No.: 09/422,998

(22) Filed: Oct. 21, 1999

(51) Int. Cl. G06F 7/00

(52) U.S. Cl. 707/4

(57) ABSTRACT

A system and method which monitor system attributes specified by a client and report the existence of a specified condition in such attributes to the client. A system and method allow a client to specify a particular condition of a system attribute of which the client desires to be notified, and the system and method derive data about the system attribute and notify the client upon detecting the existence of the specified condition. In a preferred embodiment, a reporting application receives a request from a client that specifies a query or view, which is used by the reporting application in deriving data and notifying the client of the existence of a specific condition of an attribute. The reporting application derives data about the system according to the specified query to determine if the specified condition exists, and upon determining that the condition exists, the reporting application notifies the requesting client. That is, by executing the specified query the reporting application can derive data about a system attribute to determine whether the specified condition exists. Thus, a request from the client can tailor the query of the system for the client's specific interests. Therefore, the client can specify the exact condition of an attribute in which the client is interested, which can be utterly idiosyncratic for the client, and the reporting application can derive data about the system and notify the client of the existence of a specified condition, such as a particular change in a system attribute.

### TECHNICAL FIELD

The present invention relates in general to notification of system attributes, and in specific to a reporting application that derives data about system attributes according to a query specified by a client and reports the existence of specified conditions in the attributes, such as changes in such attributes, to the client.

### BACKGROUND

Various methods have been employed in the prior art to stimulate notification regarding changes of system attributes. For example, a prior art application program may operate to investigate and obtain information about system attributes and then such program may itself figure out whether any changes have occurred in the system attributes, so that the program may account for any such changes. Thus, the application program itself may contain the complexity of obtaining information about system attributes, and determining whether any changes have occurred in the system attributes. Additionally, if changes have occurred in the system attributes, the application program may further determine whether such changes are changes that effect the program or for which the program must account.

For example, suppose a cluster of two or more nodes exists, wherein a “node” is a kernel in execution. Thus, a node may typically be referred to as a computer (although a single computer may comprise more than one processor). Changes may occur within the cluster, of which an application program desires to be made aware. For instance, the size of the cluster may reduce, e.g., because of the failure of one or more nodes in the cluster or in response to a user's action (or command) to remove one or more nodes from the cluster. Generally, when a node(s) is removed from the cluster, the remaining nodes reassemble as a smaller cluster. Typically, in the prior art, each node in the cluster executes a program, which allows the nodes to communicate among themselves and track changes in the cluster (e.g., removal or addition of a node).

Typically, a very rigid protocol is utilized to obtain information about the cluster. Generally, a consensus based algorithm is used wherein the cluster as a whole track information about changes within the cluster. More precisely, one node within the cluster is typically elected (or assigned) as the manager node, and that manager node detects changes in the cluster. Also, a different algorithm typically executes within the cluster to determine if a change has occurred with the manager node, such as the manager node being removed from the cluster. For instance, if one or more nodes other than the manager node are removed from a cluster, the manager node takes control and reassembles a consensus of the remaining nodes within the cluster. If the manager node is removed from the cluster, an algorithm executes within the cluster to elect (or assign) a new manager node, after which the new manager node then reassembles a consensus of the remaining nodes within the cluster.

Obtaining information about a cluster is undesirably complex and difficult in the prior art. Various applications executing within the cluster or in conjunction with the cluster may desire to be notified of changes that occur within the cluster, without being required to participate in the rigid protocol of the prior art. More specifically, applications can execute a command (or series of commands) to query the cluster in which the application is executing or some external cluster to determine the membership of such cluster. For example, within the UNIX operating system, an application program may utilize a command to obtain the current status of the cluster (e.g., whether the cluster is up or down) and the membership of such cluster. Alternatively, an application program may utilize its own command to obtain information regarding membership of the cluster, instead of utilizing a system call to use the operating system's command.

When an application program receives status and membership information about the cluster responsive to the application program's command, the application program must then sort through the received information to determine whether any changes have occurred within the cluster (e.g., any changes that have occurred since the application previously issued a command to obtain status and membership information about the cluster). For instance, the application program may compare the actual data received in response to an issued command querying the cluster with the actual data received in a previously issued command querying the cluster to determine any changes in the cluster. Thus, in the prior art, an application program can issue commands querying a system, and in response to such commands receive “actual” data. From such actual data, the application program itself must derive the data in which the application is interested. For example, suppose that an application program desires to know whether a particular cluster is up or down and the number of nodes within the particular cluster. The application program may issue a command querying the system, and in response to such command the application program may be returned four datum, each indicating containment of a different node by the particular cluster. However, to determine the number of nodes in the particular cluster, the application program is required to derive such information by counting the received data, which results in the sum of “4” in this example. It is important to understand that the resulting “4” of this example is not contained in the actual data received in response to the application program's command, but is independently derived by the application program counting the data. Thus, the application program is required to comprise the complexity of querying the system and deriving desired information from the results obtained from such query.

For instance, suppose that an application requires that a cluster have four or more nodes for the application to execute (or for the application to execute in a particular manner). In the prior art, such an application may sporadically or periodically query the cluster, and from the information received in response to such query, determine whether four or more nodes exist within the cluster. That is, because nodes may be added and removed from the cluster, the application itself is required to query the cluster and determine whether a sufficient number of nodes exist within the cluster for the application to execute (or to execute in a particular manner).

As a further example, suppose that an application of the prior art desires to keep track of the nodes within a cluster that contains nodes 1, 2, 3, 4 and 5. Further suppose that the application first issues a command that queries the cluster for its status and membership, and responsive to such command is returned information indicating that nodes 1, 2, 3 and 5 are contained in the cluster. From such information, the application program can execute to determine that node 4 has been removed from the cluster. At a later point in time, the program issues another command that queries the cluster for its status and membership, and responsive to such command is returned information indicating that nodes 1, 3, 4 and 5 are contained in the cluster. From such information, the application program can execute to determine that node 4 has returned (been added back to the cluster) and node 2 has been removed from the cluster. Thus, from the information received in response to the application's query, the application can “derive” that node 4 has been added to the cluster and node 2 has been removed.

Therefore, in the prior art, applications typically track the attributes of a system, such as the membership of a cluster, by issuing commands querying the system. Thus, in the prior art if an application desires to be assured of the attributes of a system before taking a particular action, the application itself is required to issue a command querying the system before taking the action. For example, suppose an application desires to send a message to all nodes within a cluster, and suppose that the application desires to be assured that the message is being sent to all nodes within the cluster and only to those nodes within the cluster. The application would be required in the prior art to first issue a command querying the cluster, and then derive data to determine the current nodes of the cluster in a manner as described in the above example. Furthermore, it should be understood that information about system attributes other than cluster membership are obtained in a like manner in the prior art.

Not only is an application required to issue a command to obtain information about the attributes of a system, but the application is required to determine from the information received responsive to such a command whether any changes have occurred in the attributes of a system, such as the current nodes of a cluster. Additionally, if it is determined that changes have occurred within the attributes, the application program must determine whether such changes are changes in which the application program is interested. For example, the application program must determine whether the changes effect how the application program is to execute. For instance, determining that a computer has been removed from a cluster may effect the way that an application desiring to send a message to all computers within the cluster executes. However, determining that a printer has been removed from the cluster may not effect the way that an application desiring to send a message to all computers within the cluster executes. Similarly, if an application program requires the existence of at least four nodes within a cluster for the application to execute, determining that node has been removed from a cluster may or may not effect the execution of the application (depending on whether four nodes still exist).Accordingly, each application program desiring information about attributes of a system is required to take an active role in issuing commands to query the system and interpret the resulting information from such commands to derive the information in which the application program is interested.

In the prior art, an application or user may be notified asynchronously of changes in system attributes. For example, a user may be notified if a printer on the system is out of ink, has a paper jam, or is out of paper. However, as explained above, if an application or user desires derived data, such as whether all printers existing on a network or within a cluster are out of paper, the user or application itself is required to derive such data from actual data received from querying the network or cluster.

Also existing in the prior art are database query languages that allow a user to specify a particular query, whereby the user can be notified of a specified condition existing within the derived data resulting from the specified query. For example, suppose a database includes many records, with each record having several fields. More specifically, suppose the database contains records of employees of a company, with each record including fields for an employee's name, address, telephone number, and other information. A user may specify a query of the database that would result in derived data. For instance, the user may specify a query using Structured Query Language (“SQL”) that results in derived data, such as whether a new employee record has been added to the database. That is, the result of such query is derived data about information contained within the database.

However, a mechanism is not available in the prior art whereby a client (e.g., an application or user) can specify a query that notifies the client of derived data about attributes of a system, such as whether at least four nodes exist within a cluster. Instead, in the prior art, a client is required to derive data about attributes of a system from actual data received from a query of the system.

### SUMMARY OF THE INVENTION

In view of the above, there is a desire for a system and method for notification of a client (e.g., a user or application) when a particular condition of a system attribute exists. For example, there is a desire for a system and method that provides notification to a client that changes have occurred in attributes of a system. There exists a further desire for a system and method that can provide notification of the existence of a particular condition of a system attribute to a client, without requiring the client to query the system and derive data necessary for determining the existence of the particular condition. There exists a further desire for a system and method that allow for continuous monitoring of the system, rather than sporadic querying of the system. For example, it would be desirable for a client to somehow be notified of specified changes in the system, without requiring the client to repeatedly issue commands to poll or query the system and determine whether a change has occurred.

Furthermore, there exists a desire for a system and method that allow for notification only of conditions of system attributes in which a client is interested. For example, a desire exists for a system and method that allow a client to somehow specify a query that is tailored to the client's interests, wherein the client will be notified of changes in the result of the query of the system upon such changes occurring. Thus, a system and method that allow the client to specify system attributes in which the client is interested, and only notify or report changes in the specified system attributes to the client are desirable.

Still a further desire exists for a system and method that allow a client to specify a query that derives data about attributes of a system and notifies the client of the resulting derived data. For example, a desire exists for a system and method that would allow a client to specify a query of the system using SQL, wherein the query will result in derived data that may be communicated to the client.

These and other objects, features and technical advantages are achieved by a system and method which monitor system attributes specified by a client and report the existence of a particular condition in such attributes to the client. A system and method of a preferred embodiment allow a client (e.g., a user or a client application) to specify a particular condition of a system attribute of which the client desires to be notified, and the system and method derive data about the system attribute and notify the client upon detecting the existence of the specified condition. For example, in a preferred embodiment, the client may specify in a request to a reporting application that the client desires to be notified of any changes in membership of nodes of a particular cluster (e.g., any nodes being added to or removed from the cluster). The reporting application may receive the request from the client and may execute the appropriate queries of the system and derive data to determine if/when a change in the membership of nodes of the particular cluster occurs. Upon detecting that a change has occurred in the membership of nodes, the reporting application may notify the client of such change, as well as the current member nodes of the cluster.

In a preferred embodiment, a reporting application receives from a client a request to notify the client of the existence of a condition of an attribute of a system. For example, the request may specify that the client desires to be notified of a change in membership nodes of a particular cluster. Thereafter, the reporting application monitors the system and derives data as specified by the client's request to determine if the specified condition exists, and upon determining that the condition does exist, the reporting application notifies the requesting client of the existence of such condition.

In a preferred embodiment, the reporting application determines whether the specified condition exists by executing a query of the system as specified by the client's request. The reporting application executes the query to derive data about a system attribute in order to determine whether the specified condition exists. Thus, in a preferred embodiment, the request from the client can tailor the query of the system for the client's specific interests. Thus, the client can specify exactly what it desires, which can be utterly idiosyncratic for the client. In a most preferred embodiment, the client can specify such a query to the reporting application as a SQL view. Thereafter, the reporting application executes the specified view(s) to derive data and notify the client as appropriate.

Many types of system attributes can be monitored by a preferred embodiment, including, but not limited to, membership of nodes within a cluster, configuration of a cluster, status of a peripheral device, failure of computer hardware, access to local peripherals, addition of shared peripherals, removal of shared peripherals, ownership of a shared peripheral, availability of shared peripherals for addition to a cluster, resilience to faults of a High Availability cluster, performance potential of a cluster, and any combination thereof. Additionally, many types of conditions may be specified by a client for triggering notification. Thus, in a preferred embodiment, the client can specify the particular type of derived data about any one or more of various system attributes that is to trigger notification from the reporting application to the client.

Moreover, in a preferred embodiment, multiple conditions may be bracketed together, such that the reporting application notifies the client of the existence of such bracketed conditions, rather than notifying the client of the existence of each condition within the bracket. That is, the reporting application may use transactions to bracket multiple changes into a single notification. If notification is provided to a client on each and every condition change, the processing of such notification might become a burden to the notified entity. Thus, the reporting application may bracket multiple such conditions into a single notification unit. In this manner, bracketed transactions may reduce the amount of notifications that are required to be supplied to a requesting client. That is, the reporting application may only provide a single notification to the client of the occurrence of multiple transactions (or changes) that are bracketed together, rather than notifying the client application of each occurrence of such transactions (or changes), if the client so desires. In a most preferred embodiment, the client can specify transactions to be bracketed together in the client's request.

It should be appreciated that a technical advantage of one aspect of the present invention is that a system and method for reporting the existence of a specified condition in a system attribute to a client are provided. A further technical advantage of one aspect of the present invention is that notification of the existence of a specified condition in a system attribute can be reported to a client without requiring the client itself to query the system and derive data necessary for determining the existence of the specified condition. A further technical advantage of one aspect of the present invention is that the system may be continuously monitored for the existence of a specified condition in a system attribute, rather than a client sporadically or periodically querying the system. Also, the client itself is not required to repeatedly issue query commands to poll the system. Still a further technical advantage of one aspect of the present invention is that a client can specify a query that the reporting application can use to derive data about attributes of a system and notify the client of particular conditions indicated by the derived data.

Yet a further technical advantage of one aspect of the present invention is that a client may be notified only of conditions of system attributes in which the client is interested. Accordingly, a client may specify the exact condition of an attribute in which the client is interested from which a query of the system may be utilized that is tailored specifically for the client's interests, which allows the reporting of the existence of a condition in a system attribute to be utterly idiosyncratic for the client. Still a further technical advantage of one aspect of the present invention is that bracketed transactions may be utilized for notification to reduce the overall number of notifications required to be reported to a requesting client.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, and the advantages thereof, reference is now made to the following descriptions taken in conjunction with the accompanying drawing, in which:

FIG. 1 illustrates an exemplary computer system adapted to use the present invention;

FIG. 2 illustrates an exemplary flow diagram of execution of a client application in a preferred embodiment; and

FIG. 3 illustrates an exemplary flow diagram of execution of the reporting application in a preferred embodiment.

### DETAILED DESCRIPTION

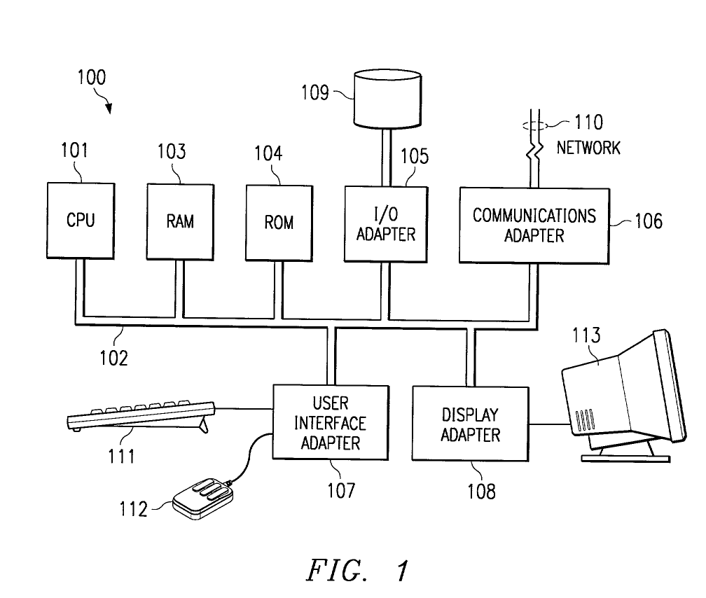

FIG. 1 illustrates an exemplary computer system 100 (or “node”) adapted to use the present invention. Central processing unit (CPU) 101 is coupled to system bus 102. The CPU 101 may be any general purpose CPU, such as an HP PA-8200. However, the present invention is not restricted by the architecture of CPU 101 as long as CPU 101 supports the inventive operations as described herein. Bus 102 is coupled to random access memory (RAM) 103, which may be SRAM, DRAM, or SDRAM. ROM 104 is also coupled to bus 102, which may be PROM, EPROM, or EEPROM. RAM 103 and ROM 104 hold user and system data and programs as is well known in the art.

The bus 102 is also coupled to input/output (I/O) controller card 105, communications adapter card 106, user interface card 107, and display card 108. The I/O card 105 connects to storage devices 109, such as one or more of hard drive, CD drive, floppy disk drive, tape drive, to the computer system. Communications card 106 is adapted to couple the computer system 100 to a network 110, which may be one or more of local (LAN), wide-area (WAN), Ethernet, Intranet, or Internet network. User interface card 107 couples user input devices, such as keyboard 111 and pointing device 112, to the computer system 100. The display card 108 is driven by CPU 101 to control the display on display device 113.

It should be understood that the present invention is not limited to the specific computer system architecture shown in FIG. 1, but may be implemented within any type of computer system. It should also be understood that other computer systems or “nodes” (not shown) may be coupled to network 110. Additionally, various peripheral devices, including but not limited to printers, optical scanners, and fax machines may be coupled directly to a computer system 100 or coupled via network 110 to computer system 100.

In a preferred embodiment of the present invention, an application comprising computer executable software code (which may be referred to herein as a “reporting application”) consumes data that is available through the system, e.g., through system calls and various other ways, and the reporting application supplies data in the form of a SQL engine which allows for queries to be executed on a system. In a preferred embodiment, the reporting application utilizes queries to derive data about the system. For example, suppose that four data exist, each indicating containment of a different node by a particular cluster. The number of nodes in the particular cluster may be derived by counting the data, which results in the sum of “4.” It is important to understand that in this example, the resulting “4” is not actual data, but is instead derived data. That is, the resulting “4” is not actually contained in the data, but is derived by counting the data. Thus, in a preferred embodiment, a reporting application executes queries to derive various data or information about a system.

In a preferred embodiment, the reporting application monitors the derived data and notifies a client, such as a human, some other computer program, or some module linked with the reporting application, when a specified condition exists in the system attribute. For example, if the client requests to be notified of a change in the system attribute, the reporting application monitors the system attribute by deriving data about such attribute and notifies the client upon detecting that a change has occurred in the derived data. In a preferred embodiment, the reporting application utilizes “views” to trigger notification of a client (e.g., a “client application” or a user) when a particular condition, such as a change, has occurred in the derived data. More specifically, the client may specify the view(s) to be utilized in querying the system to derive data about a particular system attribute(s). A “view” may be defined in many different ways. One way to think of a “view” is how that term is used within Structured Query Language (SQL). That is, a “view” may be thought of as the named output of a select statement. For example, an SQL query is typically of the form: select fields from records where a condition is met. As a simplistic example, in a preferred embodiment the reporting application may execute a query on a system of the form: select nodes from a cluster. Although, the literal SQL query utilized may be much more complex to actually perform the task of selecting nodes from a cluster.

Thus, a “view” may be thought of as the naming of the output of a particular query, which may be used thereafter in a subsequent select. For example, suppose the reporting application executes a query that selects all nodes from cluster 1, and names the resulting output or “view” Cluster 1 Nodes. Further suppose that the reporting application executes another query that selects all nodes from cluster 2, and names that resulting “view” Cluster 2 Nodes. The reporting application may then utilize the resulting views in forming further queries, such as select all nodes from Cluster 1 Nodes and Cluster 2 Nodes. Thus, the reporting application may execute queries that contain nested views or nested select statements. Moreover, in a preferred embodiment a client can specify a query to be executed by the reporting application using views. For instance, a client may request to be notified of any change in the cluster one nodes and the cluster two nodes.

As an example of a preferred embodiment, suppose a node has multiple applications (e.g., multiple client applications) executing on it that each desire to be notified of certain conditions in the system. Each client application can engage a reporting application and specify exactly what the client application wants to be notified of regarding system attributes. That is, the client application may specify a condition of a system attribute, such as a change in a particular attribute, the existence of which the client application desires to be notified. In a most preferred embodiment, the client application specifies such a condition by communication to the reporting application the query to be executed by the reporting application on the system, which may be communicated as an SQL view. Thereafter, the reporting application can utilize a query to monitor the system for the specified condition and notify the client application when such condition is detected by the reporting application. Thus, the client application itself is not required to issue commands to query the system and interpret the results obtained from such commands, but instead can engage the reporting application to notify the client application of any conditions in which the client application is interested.

Continuing with the above example, suppose that a first client application desires to be notified of any changes in the membership of nodes of a cluster. Such client application may desire to communicate messages to all member nodes of a particular cluster and only to member nodes of such cluster, and therefore desires to “know” the member nodes of the cluster. Thus, the first client application can engage the reporting application, and request that the reporting application notify the client application of any changes in the membership of nodes of the particular cluster. In the client's request, the client can specify the specific query to be executed by the reporting application to determine changes of the membership of the cluster. The reporting application may then monitor the member nodes of the particular cluster by executing the specified query to derive data about such cluster, e.g., whether any nodes have been added to the cluster or removed from the cluster. Upon detecting a change in the membership of nodes in the cluster, the reporting application may notify the client application of such change, as well as the current member nodes of the cluster.

Continuing further with the above example, suppose that a second client application desires to be notified of any changes in the status of all printers on the system. For instance, such second client application may desire to be notified if all printers on the system are out of ink, out of paper, or have paper jams, etcetera, wherein no printer is effectively available on the system. This second client application may engage the reporting application, and request that the reporting application notify the client application if all printers on the system have either an ink outage, paper outage, or paper jam. The reporting application may then monitor the system's printers by querying the system and deriving data about such printers, e.g., whether all the printers have either an ink outage, paper outage or paper jam. Upon detecting such condition(s) in the status of all the printers on the system, the reporting application may notify the client application of the existence of such condition. Therefore, the client application can engage the reporting application to notify the client if all of the printers on the system are effectively unavailable.

Further suppose that a third client application desires to be notified if the system gains or loses an “appropriate” number of disk drives required by the third application. For instance, suppose that the third client application requires at least three disk drives to be present on the system in order for the application to execute or to execute in a particular manner. This third client application may engage the reporting application, and request that the reporting application notify the client application if the system changes in a manner whereby the system gains enough disk drives such that three or more exist on the system or whereby the system loses enough disk drives such that at least three do not exist on the system. The reporting application may then monitor the system for these conditions by executing queries on the system, and notify the third client application appropriately. Therefore, the client application may engage the reporting application to notify the client whether an “appropriate” number of disk drives as specified by the application exist on the system, without the third client application itself being required to query the system and derive the data necessary to make that determination.

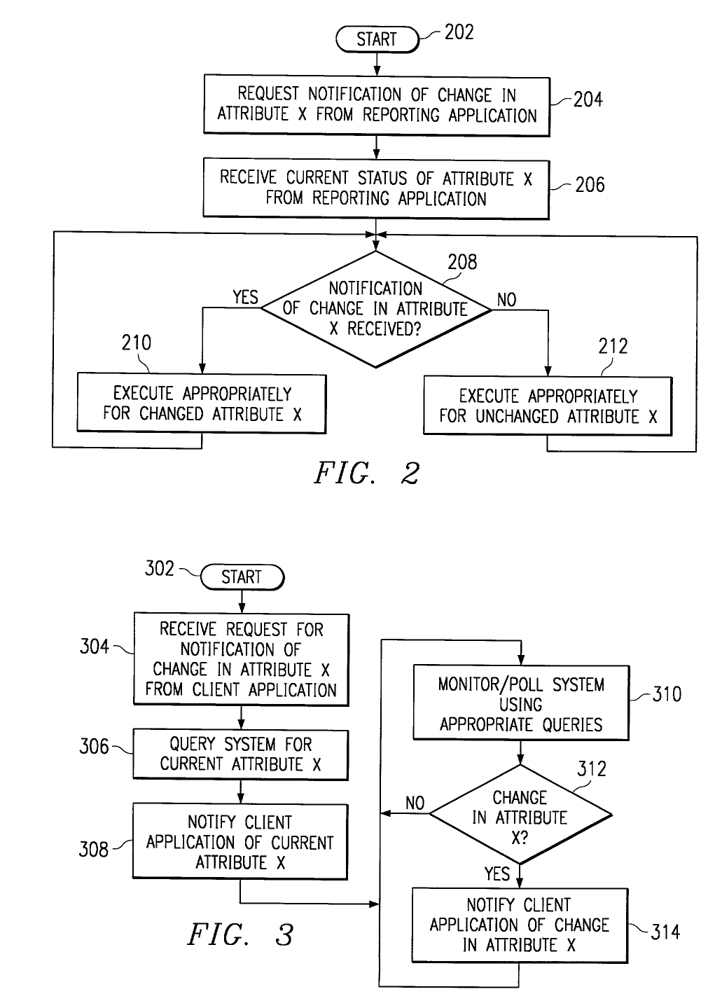

Turning now to FIG. 2, an exemplary flow diagram illustrating a possible execution of a client application in a preferred embodiment is shown. As shown, the client application may start execution at block 202. The client application may then request notification from the reporting application of the existence of a particular condition of attribute X, such as a change in an attribute X, in which the client application is interested at block 204. In a preferred embodiment, the request from the client application can tailor the query of the system for the client application's specific interests. That is, the client application can specify exactly what it desires, which can be utterly idiosyncratic for the client application. For example, if the client application is interested in the membership nodes of a particular cluster, the client application may request to be notified of any changes in such membership (e.g., addition of a node to the cluster and/or removal of a node from the cluster). For instance, the client application may specify the appropriate query to be executed by the reporting application using SQL views. At block 206, the client application may receive the current status of attribute X from the reporting application. Thus, in response to the initial request from the client application, the reporting application may communicate the current status of the attribute to the client application. Continuing with the above example, the reporting application may report the current nodes that are members of the particular cluster. It should be understood, that in alternative embodiments the initial status of attribute X may not be communicated from the reporting application to the client application, wherein block 206 may be omitted from such alternative embodiments. Additionally, some queries may not require such an initial status to be communicated to the client application. For example, suppose a client requests to be notified if at least three disk drives do not exist on the system. If at least three disk drives initially exist on the system, then no notification is required to be communicated to the client from the reporting application.

At block 208 the client application may determine whether it has received notification of the existence of the specified condition of attribute X, such as a change in attribute X, from the reporting application. If the client application receives such notification, the client application executes appropriately in response to the existence of the specified condition, e.g., the changed attribute X, at block 210. If the client application does not receive such notification, the client application executes appropriately in response to non-existence of the specified condition, e.g., the unchanged attribute X, at block 212. In either case, the client application's execution may then loop to block 208 whereby the client application is receptive to receiving notification of the existence of the specified condition (a change in attribute X in this example) from the reporting application. Continuing with the above example, suppose at block 208 the client application receives notification of a node being removed from the particular cluster. In a preferred embodiment, the reporting application may notify the client application not only of a change in the membership, but also of the nodes that are now members of the particular cluster. In response to receiving such notification from the reporting application, the client application can adapt its execution at block 210 to account for the removed node. Thereafter, if the client application does not receive notification of a change in node membership at block 208, the client application can execute according to the last notification of membership nodes received at block 212.

As the exemplary flow diagram of FIG. 2 illustrates, in a preferred embodiment the client application is not required to repeatedly poll the system for information and then determine from the received information whether a specified condition exists, such as the occurrence of a change in a particular attribute. Thus, the client application can always “know” the status of attributes in which the client application is interested without being required to repeatedly (or periodically) poll the system for such information. That is, the client application can depend on the reporting application to notify the client application of the existence of a specified condition(s) in which the client application is interested, without the client application itself being required to actively monitor/poll the system and actively make a determination of whether such specified condition(s) exist.

Additionally, the client application is not required to sporadically query the system for information and determine from the received information whether a particular condition exists, such as the occurrence of a change in a particular attribute. Thus, if the client application desires to know the status of a particular attribute before taking some action, the client application is not required to execute a command to query the system before taking such action. For example, suppose an application desires to know whether at least three disk drives exist on the system before the application executes a particular set of instructions. The application is not required to query the system and determine whether at least three disk drives exist on the system each time that the application prepares to execute that particular set of instructions. Instead, the client application can rely on the reporting application to keep the client application informed as to whether at least three disk drives exist on the system. In a sense, the client application engages the reporting application as a type of agent of the client application, whereby the reporting application monitors attributes of the system in a manner tailored to the client application's own desires, derives data about specified attributes, and reports the existence of any conditions, such as changes in the attributes, in which the client application is interested to the client application.

Turning to FIG. 3, an exemplary flow diagram illustrating execution of the reporting application in a preferred embodiment is shown. As shown, the reporting application may start execution at block 302. As discussed herein, in a preferred embodiment, an instantiation of the reporting program executes for each client application requesting reporting services from the reporting program. The reporting application receives the notification request from the client application at block 304. In a preferred embodiment, the request from the client application can tailor the query for the client application's specific interests by specifying the query to be executed on the system by the reporting application. That is, the client application can specify exactly what it desires, which can be utterly idiosyncratic for the client application. At block 306 the reporting application may query the system to determine the current/initial status of the specified attribute. Thereafter, the reporting application may notify the client application of the current status of the specified attribute (e.g., the current result of the specified query) at block 308. It should be understood, that in alternative embodiments the initial status of the specified attribute may not be communicated from the reporting application to the client application, wherein blocks 306 and 308 may be omitted from such alternative embodiments.

At block 310 the reporting application monitors/polls the system using the appropriate queries as specified by the client application's request. In response to such monitoring/polling query, the reporting application determines whether a specified condition exists, such as a whether a change has occurred in the result of such query (e.g., whether a change has occurred in attribute X specified by the client application) at block 312. If at block 312 the reporting application determines that the specified condition does not exist (e.g., no change has occurred in the result of the specified query), the reporting application's execution may loop to block 310 to continue monitoring/polling the system according to the query specified by the client application. On the other hand, if at block 312 the reporting application determines that a specified condition does exist (e.g., a change in the result of the specified query has occurred), the reporting application notifies the client application of such condition at block 314. Thereafter, the reporting application's execution may loop to block 310 to continue monitoring/polling the system according to the query specified by the client application.

In a preferred embodiment, the reporting application not only notifies the client application that a change has occurred, but also notifies the client application of the new result of the specified query (e.g., the new status of attribute X). For example, suppose a client application requests to receive notification of a change in membership of nodes in a particular cluster. In a preferred embodiment, if the reporting application detects a change in the membership of the particular cluster, the reporting application may notify the client application not only that a change has occurred, but also of the new result of the specified query (e.g., the nodes that are now members of the particular cluster).

Multiple applications may be executing on a single node, and in a preferred embodiment each application desiring reporting services can connect to an instantiation of the reporting application. That is, when a client application engages the reporting application or requests reporting services, the client application may cause an instantiation of the reporting application to begin executing for such client program. In a preferred embodiment, a single instantiation of the reporting application executes to perform all monitoring and reporting services for the client application. Although, a client application may engage any number of instantiations of the reporting application. Moreover, it is intended to be within the scope of the present invention for a single reporting application (or a single instantiation thereof) to provide reporting services for more than one client. Typically, an instantiation of the reporting program is executing on a different computer (or node) than the requesting client application, although it is within the scope of the present invention for such reporting program to be executing on the same computer (or node) as the client application.

In a preferred embodiment, client applications can specify one or more of many different types of conditions that may exist in one or more of many different system attributes to be reported by the reporting application to the client application. As discussed above, in a most preferred embodiment the client application specifies the condition of an attribute to trigger notification by specifying the query to be executed by the reporting application using SQL views. That is, in a most preferred embodiment, the client application communicates an SQL query (using views) to the reporting application, which specifies the conditions of attributes in which the client desires to be notified. Several examples of such types of conditions of system attributes that may be monitored and reported to a client application in a preferred embodiment are discussed in greater detail below. However, it should be understood that many other types of conditions and attributes may be monitored and reported to a client application, and any such condition and attribute is intended to be within the scope of the present invention. Thus, the present invention is not intended to be limited only to the conditions and attributes provided herein, but rather such conditions and attributes are intended as examples that render the disclosure enabling for many other types of conditions and attributes that may be monitored and reported to client applications.

The reporting application may trigger notification of a client (e.g., a user or a client application) of changes in derived data. For example, a client application may specify that it desires to be notified of changes in membership of nodes within a particular cluster. The reporting application may utilize views to query the system and derive data regarding the membership of nodes within the particular cluster. Additionally, the reporting application may utilize views to query the system and derive data regarding whether such membership of nodes within the particular cluster has changed, and if it has changed, the reporting application may notify the client application of the change, as well as the new member nodes of the particular cluster. For instance, the reporting application may initially query the particular cluster to determine member nodes of the cluster, and the reporting application may name the resulting derived list of member nodes (i.e., the resulting view) “Old Membership Nodes.” Thereafter, the reporting application may poll the system with the query: “Old Membership Nodes =Current Membership Nodes?,” wherein “Current Membership Nodes” represents a derived list of the member nodes of the particular cluster at any given time. Thus, the reporting application may utilize views to detect changes in derived data and notify the requesting client application of such changes.

The reporting application may notify a client of changes in cluster configuration. Clusters are typically configured to contain hardware and software components, which may change as a result of administrative action. A client can be notified of such changes (which are typically detected by the reporting application through derived data), in a preferred embodiment. Similarly, the reporting application may notify a client of changes in a “High Availability Cluster” configuration. A High Availability cluster is a cluster that contains at least two nodes (two computers), each of which are capable of performing a desired task should the other fail or otherwise be unavailable. It should be understood that unless specifically indicated herein as a High Availability Cluster, the term cluster as used herein is intended to refer to any type of cluster, including but not limited to High Availability clusters. High Availability clusters are typically configured to contain certain hardware and software components, which may change as a result of administrative action. A client can be notified of such changes (which are typically detected by the reporting application through derived data), in a preferred embodiment.

The reporting application may notify a client that shared peripherals have been added or deleted within a cluster. Peripherals are routinely added or deleted from a cluster. In a preferred embodiment, a client can be notified by the reporting application of such changes (which are detected by the reporting application through derived information). Similarly, the reporting application may use views to notify a client that shared peripherals have been added or deleted within a High Availability cluster. Peripherals are routinely added or deleted from a High Availability cluster. In a preferred embodiment, a client can be notified by the reporting application of such changes (which are detected by the reporting application through derived information).

The reporting application may notify a client that the performance potential of a cluster has changed. The performance potential of a cluster is determined by a combination of available hardware and software configuration. A client can be notified of changes in such hardware availability and software configuration by use of view notification by the reporting application. Similarly, the reporting application may notify a client that the performance potential of a High Availability cluster has changed. The performance potential of a High Availability cluster is determined by a combination of available hardware and software configuration. A client can be notified of changes in such hardware availability and software configuration by use of view notification by the reporting application.

The reporting application may notify a client of failures of computer hardware. Hardware, such as disk drives, adapter cards, and cables, as well as many other various types of hardware, occasionally fail. A client can be notified of such failures (which may or may not be detected by the reporting application through derived data) by use of view notification by the reporting application. Similarly, the reporting application may notify a client of failures of components within a High Availability Cluster. High Availability clusters rely on redundant hardware and software to maintain resilience to failure. After a failure, the surviving configuration will be different. A client can be notified of such changes (which are usually detected by the reporting application through derived data), by use of view notification by the reporting application.

The reporting application may notify a client that other computers can access local peripherals. Due to hardware and software reconfiguration, additional computers may gain access to local peripherals. A client can be notified of the existence of such new computers, by use of view notification by the reporting application. Additionally, the reporting application may notify a client that shared peripherals are available for addition to a cluster. Clusters typically share peripherals. Connecting and configuring a peripheral may make the peripheral available to the cluster. A client can be notified of the addition of such available peripherals by use of view notification by the reporting application. Similarly, the reporting application may notify a client that shared peripherals are available for use in a High Availability cluster. High Availability clusters typically share peripherals. Connecting and configuring a peripheral may make the peripheral available to the High Availability cluster. A client can be notified of the addition of such available peripherals by use of view notification by the reporting application.

The reporting application may notify a client that a particular computer has claimed ownership of a shared peripheral. While a peripheral is potentially shared, at any point in time such peripheral may be controlled by a particular computer. Such a state of ownership may exist with respect to a computer that is within or without a particular cluster. Avoiding conflicting ownership is desirable. Thus, a client can be notified of claims of ownership by use of view notification by the reporting application. Likewise, the reporting application may notify a client that a particular computer has relinquished ownership of a shared peripheral. Again, because avoiding conflicting ownership is desirable, a client can be notified of relinquishment of ownership by use of view notification by the reporting application.

The reporting application may notify a client that a High Availability cluster has lost resilience to faults. Following the loss of a single component of a high availability cluster, the surviving cluster may not be resilient to faults. A client can be notified of this transition from fault-resilient to not-fault-resilient by use of view notification by the reporting application, which uses derived data to detect such a condition. Likewise, the reporting application may notify a client that a High Availability cluster has gained resilience to faults. A High Availability cluster routinely has components added to the cluster. If such additions cause a transition from not-fault-resilient to fault-resilient, the user is notified by use of view notification by the reporting application, which uses derived data to detect such a condition.

The reporting application may use transactions to bracket multiple changes into a single notification. If notification is provided to a client on each and every data change, the processing of such notification might become a burden to the notified entity. Thus, it is desirable to bracket multiple such modifications into a single notification unit. Database transactions have long been used to bracket multiple database changes into a single atomically applied set. For example, suppose a bank database brackets the transfer of funds from a first account to a second account as a single atomically applied set. Such bracketing ensures that the database will recognize the entire bracketed transaction or none of it. Thus, if the bank's computer system crashes in the middle of a transfer, the database will not recognize removal of funds from the first account without recognizing the addition of the funds in the second account. Rather, the database will either recognize the entire transfer activity or none of it.

In a similar manner, the reporting application may use transactions to bracket changes with respect to notification requirements. For example, suppose that a disk is moved within a system from a first logical construct to a second logical construct. A client may only want to be notified of the disk being moved, rather than being notified that the disk was removed and then being notified that it was added. Thus, a disk being moved from one logical construct to another may be bracketed into a single notification, wherein the client is notified only of the resulting move. In this manner, bracketed transactions may reduce the amount of notifications that are required to be supplied to a requesting client. That is, the reporting application may only provide a single notification to the client of the occurrence of multiple transactions (or changes) that are bracketed together, rather than notifying the client application of each occurrence of such transactions (or changes).

The reporting application may notify a graphical user interface (GUI) that re-draw of the graphics is indicated. A GUI that displays data representing various states must be regularly updated to reflect changes in such state data. The reporting application may use views to present derived data to the GUI, and changes in the data being presented on the GUI may trigger notification to the GUI to allow the GUI to update its display. For example, a GUI may display a substantially real-time graphical representation of a system's performance, such as a line graph that shows the current percentage of CPU being consumed by the system. The GUI may engage the reporting application to monitor the system's CPU consumption and notify the GUI of changes, in order that the GUI can update its line graph display accordingly.

A GUI generally has as one of its primary characteristics the ability to display information in a manner appropriate for a human user. That is, the GUI displays information in a manner such that within a reasonable level of abstraction a user can understand the displayed information. In a preferred embodiment, a GUI application may specify the information (or conditions) that it would like to have reported to it, and the reporting application can monitor the system for such information and report the information in the manner specified by the GUI application. For example, a GUI application that displays a map illustrating the current state of a cluster (including the node membership of the cluster) may engage the reporting application to notify the GUI of changes within the cluster so that the GUI can update its display accordingly. Thus, in a preferred embodiment, the reporting application may monitor the cluster using views in the manner specified by the GUI and notify such GUI of the need to redraw the map illustrating the current state of a cluster (including the node membership of the cluster).

It should be understood that even though the above primarily describes the client as an application, in a preferred embodiment the client may be any type of entity, including a human user. Thus, the reporting application may receive a request from any type of client for notification of a particular condition of a system attribute, and the reporting application may provide notification to any type of client in response to detecting the specified condition of the system attribute. It should also be understood that in a preferred embodiment notification from the reporting application to a client may be provided in a synchronous or asynchronous manner, responsive to a request from the client.

Additionally, in a preferred embodiment, the reporting application comprises computer executable software code. Although, in some embodiments the reporting application may comprise software, hardware, firmware, or any combination thereof, and any such embodiment is intended to be within the scope of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of reporting existence of a specified condition in a system attribute, said method comprising:
receiving a request from a client to notify said client of a condition of an attribute of a system, wherein said request comprises information specifying a query for said system attribute;
querying said system as specified by said request;
deriving data about said system attribute to determine if said condition exists; and
upon determining that said condition exists, notifying said client of the existence of said condition.

2. The method of claim 1, wherein said deriving data comprises generating derived data based upon the result of said query of said system.

3. The method of claim 1, wherein said condition is a change in said attribute.

4. The method of claim 1, wherein said attribute is selected from the group consisting of:
membership of nodes within a cluster, configuration of a cluster, status of a peripheral device, failure of computer hardware, access to local peripherals, addition of shared 5 peripherals, removal of shared peripherals, ownership of a shared peripheral, availability of shared peripherals for addition to a cluster, resilience to faults of a High Availability cluster, performance potential of a cluster, and any combination thereof.

5. The method of claim 1, wherein said client is selected from the group consisting of a user and a client application program.

6. The method of claim 1, wherein said information specifying a query for said system attribute is an SQL query.

7. The method of claim 6, wherein said SQL query comprises an SQL view.

8. The method of claim 1, wherein said information specifying a query for said system attribute comprises multiple transactions bracketed together.

9. The method of claim 1, wherein said condition comprises:
multiple conditions bracketed together, wherein upon determining that such bracketed conditions exist, notifying said client of the existence of such bracketed conditions.

10. The method of claim 9, wherein said condition comprises:
multiple changes bracketed together, wherein upon determining that such bracketed changes exist, notifying said client of the existence of such bracketed changes.

11. The method of claim 1, wherein said client is a graphical user interface (GUI) that displays information to a human user.

12. The method of claim 11, wherein said GUI displays information about one or more attributes of a system to a human user, and wherein said deriving data comprises deriving data to determine if a condition of said one or more attributes exists such that the GUI should redraw the graphics displaying said information about said one or more attributes.

13. A reporting application for reporting the existence of a specified condition in a system attribute to a client, said reporting application comprising:
computer executable software code for receiving from a client a request to notify said client of a condition of an attribute of a system, wherein said request comprises information specifying a query for said system attribute;
computer executable code for querying said system as specified by said request;
computer executable software code for deriving data about said system attributes;
computer executable software code for determining from said derived data if said condition exists; and
computer executable software code that, upon determining that said condition exists, notifies said client of the existence of said condition.

14. The reporting application of claim 13, wherein said information specifying a query for said system attribute is an SQL query.

15. The reporting application of claim 14, wherein said SQL query comprises an SQL view.

16. The reporting application of claim 13, wherein said condition is a change in said attribute.

17. The reporting application of claim 13, wherein said condition comprises:
multiple conditions bracketed together, wherein upon said computer executable software code determining that such bracketed conditions exist, said computer executable software code notifying said client of the existence of such bracketed conditions.

18. A system for reporting the existence of a specified condition in a system attribute to a client, said system comprising:
means for storing a reporting application;
a means for executing said reporting application;
wherein said reporting application includes computer executable software code for receiving from a client a request to notify said client of a condition of an attribute of a system, said request comprising information specifying a query for said system attribute, computer executable software code for determining if said condition exists, and computer executable software code that, upon determining that said condition exists, notifies said client of the existence of said condition.

19. The system of claim 18, wherein said client is selected from the group consisting of a user and a client application program.

20. The system of claim 18, further comprising:
multiple nodes, wherein at least one of said nodes is executing said reporting application.
